(19) United States
(12) Patent Application Publication
(10) Pub. No.: US 2025/0027322 A1
(43) Pub. Date: Jan. 23, 2025

(54) WALL LINING MESH

(71) Applicant: DENVELOPS TEXTILES, S.L., IGUALADA (ES)

(72) Inventors: Jaume COLOM TALLO, Igualada (ES); Jordi RIBA TORRAS, Igualada (ES); Pere RIBA TORRAS, Igualada (ES)

(73) Assignee: DENVELOPS TEXTILES, S.L., IGUALADA (ES)

(21) Appl. No.: 18/706,926

(22) PCT Filed: Nov. 2, 2022
(86) PCT No.: PCT/ES2022/070707

§ 371 Date: May 2, 2024

(30) Foreign Application Priority Data
Nov. 3, 2021 (ES) U202132155

(51) Int. Cl. E04F 13/12

(52) U.S. Cl. CPC E04F 13/126

(57) ABSTRACT

Wall lining mesh having a plurality of parallel wefts intended to be oriented preferably stacked at different levels and each extending over a length dimension; and a plurality of links connecting the wefts to one another. The wefts have a spiral shape wound around a notional core of revolution or a notional core having a polygonal cross-section, each weft having an alternating sequence of peaks and valleys with segments which extend in a direction having a component normal to the length dimension and which can pass through links, with each link surrounding a peak and a valley of different wefts.

### TECHNICAL FIELD OF THE INVENTION

The invention relates to a wall lining mesh, of the metal mesh or fabric type, suitable for making double-skinned, openwork architectural linings, for example, on a wall of a building.

### BACKGROUND OF THE INVENTION

Many proposals are known in the field of constructive solutions for assembling metal mesh-type double-skinned linings. The most common proposals are based on systems consisting of metal meshes that are all flexible and can be wound up, in which the combination of wefts and warps or of intertwined wefts generate fabrics with several degrees of opacity and different finishing solutions.

Document FR2965739 presents a constructive solution based on spiral wefts connected by straight rods which allow forming meshes that allow covering the walls of buildings. To manufacture this mesh, there is a need to pass through pairs of spiral wefts attached by means of a rod, securing each rod to prevent it from coming out from between the pair of spiral wefts that it secures.

To achieve increased mesh stability, the solution presented by documents U.S. Pat. Nos. 8,006,739, 9,241,591, and 7,779,888 is known, in which the architectural mesh is formed by a plurality of spiral wefts connected by zig-zag rods, with both the spiral wefts and the zig-zag rods determining peaks and valleys, and with spiral wefts being alternated with zig-zag rods, such that each peak and valley of each spiral weft is housed, respectively, in a valley and a peak of a zig-zag rod. A better position of the spiral wefts is thereby achieved. To manufacture this mesh, there is a need to pass through pairs of spiral wefts attached by means of a zig-zag rod, securing the ends of the wefts to prevent them from moving.

Document EP2171348 also discloses a metal mesh formed by zig-zag wefts interconnected by links, which requires complex machinery that gradually bends the wefts and moves them forward, incorporating links that must perform a back-and-forth movement following the zig-zag of the wefts.

Therefore, an objective of the present invention is to disclose a wall lining mesh which allows greater ease of assembly.

Furthermore, another objective of the present invention is to disclose a wall lining mesh which presents great versatility in terms of the accessories to be supported.

Another objective is to disclose an alternative to known wall lining meshes.

### DESCRIPTION OF THE INVENTION

The wall lining mesh of the invention comprises a plurality of parallel wefts intended to be oriented preferably stacked at different levels and each extending over a length dimension; and a plurality of links connecting said wefts to one another. The mesh is essentially characterised in that the wefts have a spiral shape wound around a notional core of revolution or a notional core having a polygonal cross-section, each weft comprising an alternating sequence of peaks and valleys with segments which extend in a direction having a component normal to the length dimension and which can pass through links, with each link surrounding a peak and a valley of different wefts. Therefore, it is envisaged that these different wefts may or may not be successive wefts. Advantageously, the spiral shape of the wefts, for example helicoidal or flattened helicoidal shape, allows winding the mesh for transport in addition to preventing the links from being able to move along the weft, given that they would have to cause the rotation or movement of other links in order for come out.

Therefore, the mesh can be manufactured by arranging the links in a fixed position and advancing each of the wefts in a horizontal direction, while they rotate about themselves, such that the wefts, for example spiral-shaped helicoids, are gradually inserted in the respective links such that, in one embodiment, the wefts are helicoids, thereby allowing the wefts to be readily advanced or held back, if necessary, until they are fixed in their desired position.

It is also contemplated that these helicoids can optionally be levelled or flattened, such that the wefts of the mesh are flattened helicoids and essentially arranged on one and the same plane, thereby achieving a more compact wall lining mesh. Therefore, the wefts have a cyclonic-type appearance and the fabric has sufficient integrity to withstand transport and installation, as well as a sufficient service life once the mesh is applied, for example, on a wall and used as a constructive system for a wall lining suitable, for example, for double-skinned, openwork architectural linings having an appearance and capacities similar to those already known metal meshes or fabrics, and to metal mesh-based constructive fabrics. Optionally, finishing parts or components can even be fixed in order to provide functionality to the fabrics, although with a much simpler manufacture and allowing the combination of different types of links.

In one embodiment, the mesh comprises links closed along the perimeter and have at least one through hole through which at least one of the two successive wefts passes. Although it is contemplated for the links to be closed parts, it is also envisaged that the links are open parts, like staples, that must be closed when manufacturing the mesh by attaching the peaks and valleys of two successive wefts.

Specifically, in one embodiment, the mesh comprises links having two through holes through which each of the two successive wefts passes, such that each weft passes through a different through hole.

In another embodiment, the mesh has links having a single through hole through which two successive wefts pass. In this case, it is further achieved that the two successive wefts can be moved closer to one another, causing a compression effect in the mesh which facilitates transport. In this case, it would be even possible that, if the size of the eye of the through hole is larger than the helicoid formed by the wefts, the wefts can pass directly through the through hole without having to rotate the helicoid. Naturally, it is also envisaged for more than two wefts, for example three wefts, to be able to pass through the through hole, such that the link is arranged between the peak and the valley of two different wefts and a third weft can pass through the link therebetween. It is also envisaged for the mesh to combine links with one through hole, links with two through holes, and even links with more through holes.

In one embodiment, the mesh comprises links inscribed in planes parallel to one another, such that the links are aligned in the same manner and parallel to the plane determined by the mesh, for example, forming a homogenous and essentially planar mesh.

In an embodiment of interest, at least two successive links connected to the same wefts are furthermore attached to one another by means of an attachment portion, such that they form a single part. Naturally, several links can be attached to one another by means of one or more attachment portions; it is even envisaged for two successive wefts to be attached by means of links attached to one another by means of attachment portions, forming a single part.

In one embodiment, the mesh comprises links provided with flanges which allow the mesh to cast characteristic shades over the wall or surface on which the mesh is installed.

In one embodiment, the flanges are attached in an articulated manner to the links, such that the shape and type of shades cast by the mesh can be varied. Naturally, it is contemplated that the flanges can also be indirectly attached to the links, for example with the flanges being attached to attachment portions between links. Depending on the type of desired effect, the articulated attachment confers greater or lesser degree of retention. In this sense, if it is desired for the flanges to move with the wind, for example, the articulated attachment will be lightweight, whereas if it is desired for a position of the flanges to be manually established and for this position to be maintained in the mesh, the articulated attachment will have greater tightening.

In one embodiment, the wefts are filiform wefts, and it is envisaged for the wefts to be formed from a round or flat wire.

For example, it is envisaged for the mesh to comprise links that are laser-cut or die-cut steel sheets. Naturally, other types of materials can be used for manufacturing both the wefts and the links.

### BRIEF DESCRIPTION OF THE DRAWINGS

To complement the description that is being made and for the purpose of facilitating the understanding of the features of the invention, a set of drawings is attached to the present specification in which the following is depicted in an illustrative and non-limiting manner:

FIG. 1a shows an embodiment of the mesh in which the wefts are flattened helicoids in which the links are essentially coplanar to the weft;

FIG. 1b shows the mesh of FIG. 1a in which portions of the wefts and links for forming openings in the mesh have been removed;

FIGS. 2a, 2b, and 2c shows a front view of a method for constructing a mesh according to the invention;

FIG. 2d shows a side view of the mesh of FIG. 2c;

FIGS. 3a and 3b show an additional step of flattening the mesh of FIG. 2d;

FIGS. 4a and 4b show another mesh according to the invention provided with side flanges in some links;

FIG. 5 shows another mesh according to the invention provided with another type of flanges in the links;

FIG. 6 has different types of links which can be combined to form a mesh according to the present invention;

FIG. 7 shows another mesh according to the invention having links attached to one another between consecutive wefts;

FIG. 8 shows another mesh according to the invention also having links attached to one another between consecutive wefts;

FIG. 9 shows another mesh according to the invention which combines different types of links and attachment portions between links;

FIG. 10 shows another mesh according to the invention, with links having a through hole for each consecutive weft;

FIGS. 11 and 12 show other meshes according to the invention which combine different types of links;

FIG. 13 shows a mesh according to the invention which incorporates additional elements on the links;

FIG. 14 shows another mesh according to the invention provided with flanges by way of banners;

FIG. 15 shows another mesh according to the invention provided with LED strips;

FIG. 16 shows another mesh according to the invention in which the wefts are non-flattened helicoids; and

FIG. 17 shows another mesh according to the invention in which one and the same link surrounds more than one valley of one and the same weft or more than one peak of one and the same weft.

### DETAILED DESCRIPTION OF THE DRAWINGS

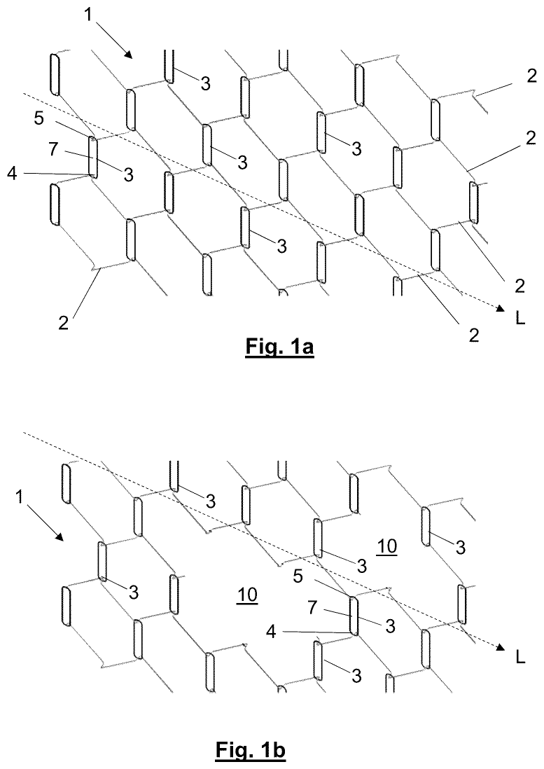

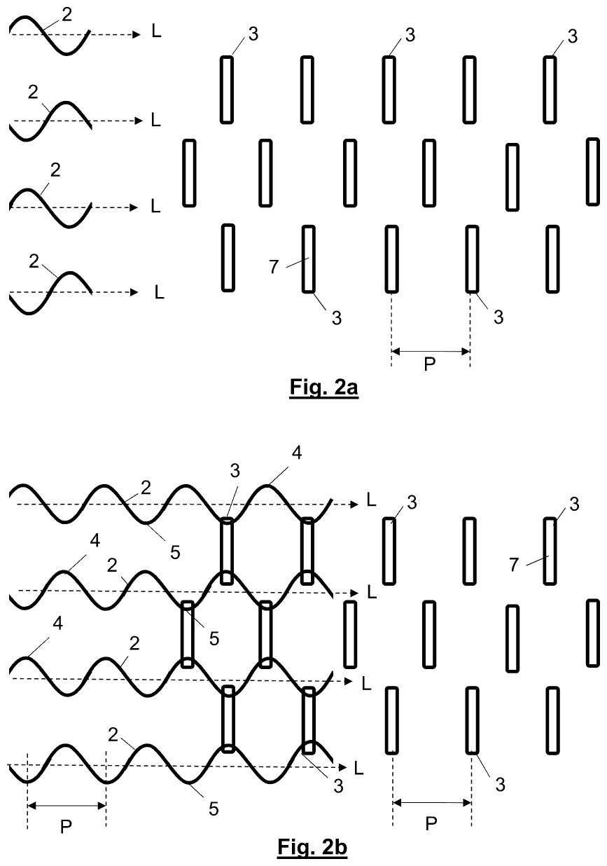

FIG. 1a shows a portion of a wall lining mesh 1 adapted, for example, to be arranged on a wall, comprising a plurality of parallel wefts 2 intended to be oriented preferably stacked at different levels and each extending over a length dimension L. The mesh 1 further comprises a plurality of links 3 connecting said wefts 2 to one another. It should be noted that the wefts 2 have a spiral shape wound around a notional core of revolution or a notional core having a polygonal cross-section, each weft 2 comprising an alternating sequence of peaks 4 and valleys 5 with segments which extend in a direction having a component normal to the length dimension L and which can pass through links 3, with each link 3 surrounding a peak 4 and a valley 5 of different wefts 2. The wefts 2 can be of the known type such as helicoidal or cyclonic wefts arranged in essentially horizontal directions and parallel to one another. In this mesh 1, it can be seen that all the peaks 4 and the valleys 5 of successive wefts 2 are connected by means of respective links 3. Naturally, it is envisaged that the peaks 4 of the weft 2 at the upper end of the mesh 1 and the valleys 5 of the weft 2 at the lower end of the mesh 1, which determine the perimeter of the mesh 1, can be devoid of links 3. Furthermore, it should be noted that, in the mesh 1, the links 3 are closed along the perimeter and have a through hole 7 through which two successive wefts 2 pass. The wefts 2 are filiform wefts, specifically the wefts 2 can be formed from a round or flat wire suitably bent initially into a helicoidal shape, forming a spiral, and can be optionally flattened, according to the method which will be described below. The links 3 can be formed by laser-cut or die-cut steel sheets.

It should be noted that in FIG. 1a each successive helicoidal weft 2 rotates in one and the same opposite sense in one and the same direction, therefore if one weft 2 rotates counterclockwise to the right, its successive upper and lower wefts 2 rotate clockwise to the left, whereas if a weft 2 rotates to the left, its successive upper and lower wefts 2 rotate to the right, therefore the links 3 surrounding a peak 4 and a valley 5 of successive wefts 2 are arranged coplanar to one another, such that the mesh 1 comprises links 3 inscribed in planes parallel to one another, and which are in turn inscribed in the plane determined by the wefts 2 of the mesh 1, such that the mesh 1 is substantially planar.

Naturally, successive wefts 2 can also rotate in one and the same sense, both clockwise and counterclockwise, such that the links 3 surround a peak 4 and a valley 5 of successive wefts 2 rotating in the same sense. It is also envisaged to combine wefts 2 that rotate to the right with wefts 2 that rotate to the left in one and the same mesh 1.

In the mesh 1 depicted in FIG. 1a, all the peaks 4 and the valleys 5 of successive wefts 2 are connected by means of respective links 3, which allows the wefts 2 to be held together better; however, it is also envisaged that only some peaks 4 and valleys 5 have links 3 arranged therebetween.

FIG. 1b shows a mesh 1 in which only some of the peaks 4 and valleys 5 of successive wefts 2 are connected by means of links 3. Therefore, it is contemplated that, starting from a mesh 1 such as the one depicted previously in FIG. 1a, openings 10 can be formed both by cutting out the wefts 2 and removing the links 3.

To manufacture the mesh 1, it is envisaged, starting from wefts 2 wound in a helicoidal manner with a pitch P, to thread or sew the wefts 2 onto the links 3, passing the wefts 2 through the through holes 7 of the links 3, such that the links 3 are arranged in the peaks 4 and valleys 5 of each weft 2, subsequently flattening the wefts 2 to achieve the cyclonic spiral shape shown in FIG. 1a.

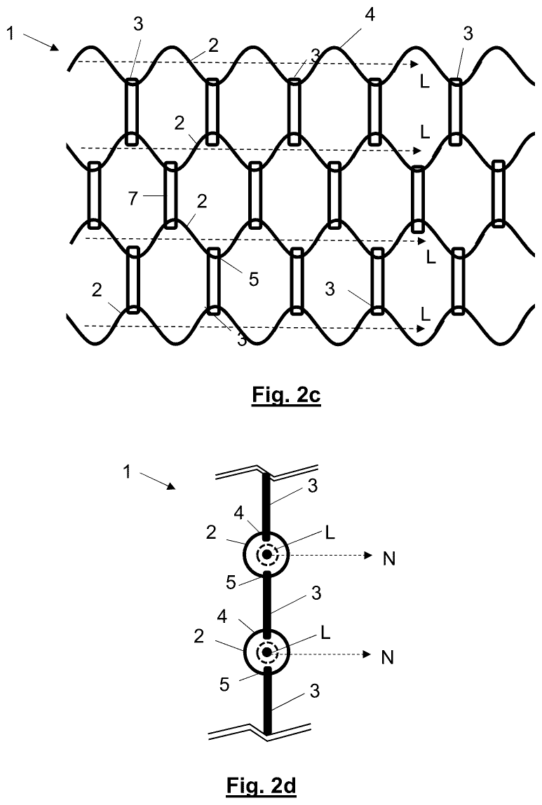

This method is illustrated in the sequence of FIGS. 2a to 2c. As can be seen, to manufacture the mesh 1 according to the invention, the links 3 are first arranged fixed in an alternating manner, suitably separated along the length dimension L in which the wefts 2 will extend by one pitch P of the weft 2. In this way, as the wefts 2, which are suitably arranged in opposing phase in an alternating manner, gradually rotate on themselves in a guided manner, they gradually advance and sew the links 3 through the through holes 7 in the manner illustrated, such that the wefts 2 are inserted link 3 by link 3 in a manner similar to what would be performed to bind a notebook with a spiral that passes through the eyelets of the pages, thereby forming the mesh 1 of the present invention. Although only four wefts 2 and three rows of links 3 have been illustratively depicted, it is envisaged that there may be a much larger number of wefts 2 and links 3 per weft 2, depending on the mesh 1 to be made.

FIG. 2d shows a part of the side view of the mesh 1 of FIG. 2c in which it can be seen that the wefts 2 are formed by helicoids having a circular section, i.e., in this case, they have a spiral shape wound around a notional core of revolution which would be a cylinder having a circular section. It can be seen in each weft 2 the alternating sequence of peaks 4 and valleys 5, in this case stacked in this side view, with the segments of the weft 2 which extend in a direction having a component normal to the length dimension L, having in this case said normal N, and which can pass through the links 3, with each link 3 surrounding a peak 4 and a valley 5 of different wefts 2.

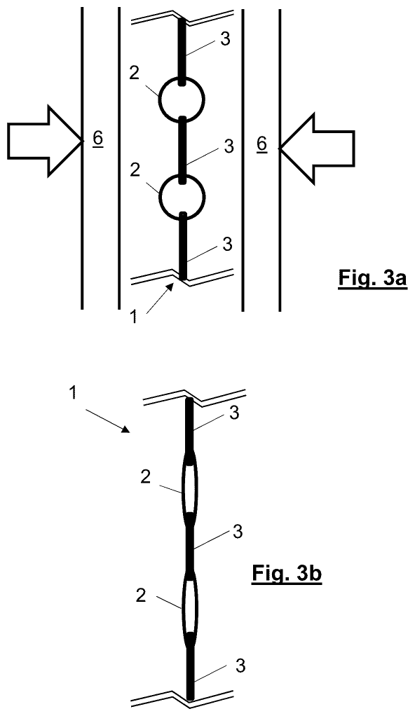

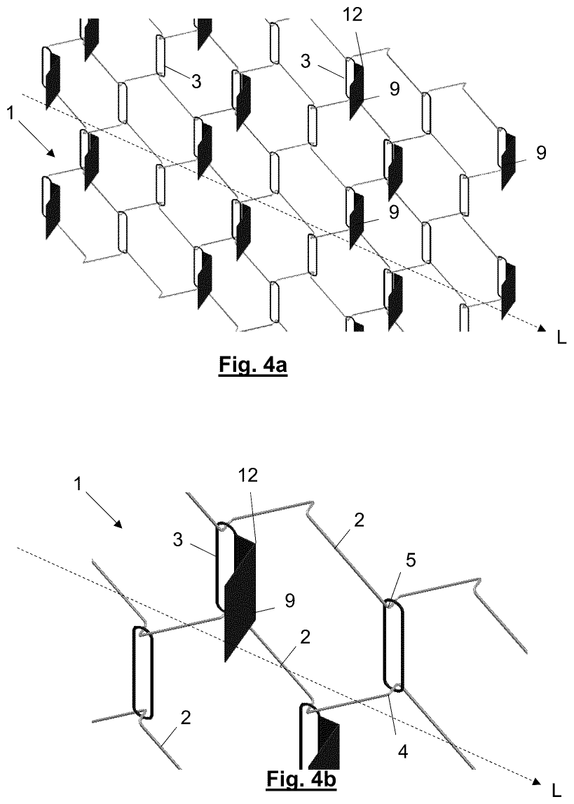

Although the mesh 1 formed by helicoids having a circular section can already be wound for storage and use for wall lining, for a better finishing, it is envisaged to flatten the mesh 1 by means of a pair of presses 6, for example, as illustrated in FIG. 3a, such that it is achieved that the wefts have a spiral shape wound around a notional core of revolution which in this case would be a cylinder with an elliptical section, i.e., the wefts are flattened helicoids. Naturally, it is envisaged to be able to use other types of presses 6 to form other spiral shapes wound around other notional cores of revolution or even notional cores having a polygonal cross-section, for example a prism with a square or rectangular base if pressure is exerted on all four sides, such that the wefts 2 even form straight ascending and descending segments, with perpendicular portions that pass through the links 3.

FIG. 4a and the detail thereof in FIG. 4b show another embodiment of the wall lining mesh 1 in which some of the links 3 thereof have a side flange 9 which allows giving volume to the mesh 1 and furthermore casting a characteristic shade on the wall on which the mesh 1 is arranged. By means of these flanges 9, the appearance that the wall will have during daylight hours can advantageously be varied based on the position of the sun and the shade cast on the wall. It is envisaged for the flange 9 to be formed integrated with the link 3, such that it can be formed together from the same material. Naturally, it is also envisaged for the links 3 to be provided with several flanges, or for the flanges 9 to be able to be manually fitted, for example after flattening the wefts 2. It is also envisaged for the flanges 9 to have folds 12 that allow the flanges 9 to protrude from the plane determined by the wefts 2 of the mesh 1.

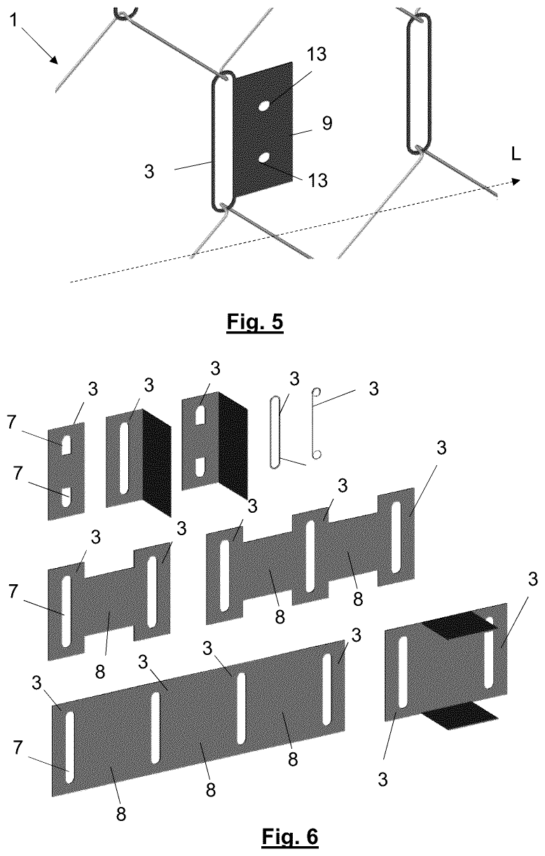

FIG. 5 shows a detail of a mesh 1 according to the invention comprising a link 3 provided with a flange 9, wherein the flange 9 is in turn provided with perforations 13 that allow the flange 9 to cast a shade with lighting parts, achieving an improved effect in the shade cast by the mesh 1 on the wall in which it is placed. Naturally, these perforations 13 could be made in another type of flanges 9, such that the cast shade would have brighter motifs.

FIG. 6 shows a selection of different links 3 that can be used to manufacture a mesh 1 according to the present invention. It should be noted that these links 3 can be combined in different manners to attach consecutive wefts 2 of the mesh 1. It should be noted that these links 3 are closed along the perimeter and have at least one through hole 7 through which at least one of the two successive wefts 2 passes, such that successive wefts 2 are attached to form the mesh 1. Specifically, it can be seen that some links 3 have two through holes 7 through which each of the two successive wefts 2 will pass, whereas other links 3 have a single through hole 7 through which two successive wefts 2 will pass, for example an elongated through hole which allows the wefts 2 to be able to pass therethrough. Furthermore, it is contemplated that the links 3 can be provided with flanges 9, as seen above; it is also envisaged for several links 3 to be attached to one another by means of attachment portions 8, such that at least two successive links 3 connected to the same wefts 2 can furthermore be attached to one another by means of this attachment portion 8. It is furthermore envisaged that the attachment portion 8 can be provided with flanges 9, which can even be cut-outs of said attachment portion 8, such that the mesh 1 comprises links 3 attached to respective flanges 9, where said flanges 9 can furthermore be articulated with respect to the links 3, having a hinge between the link 3 and the flange 9, for example, such that the mesh 1 comprises links 3 attached in an articulated manner to the respective flanges 9. It is also envisaged that the flange 9 or flanges 9 can also be articulated with respect to the attachment portion 8 attaching two or more links 3.

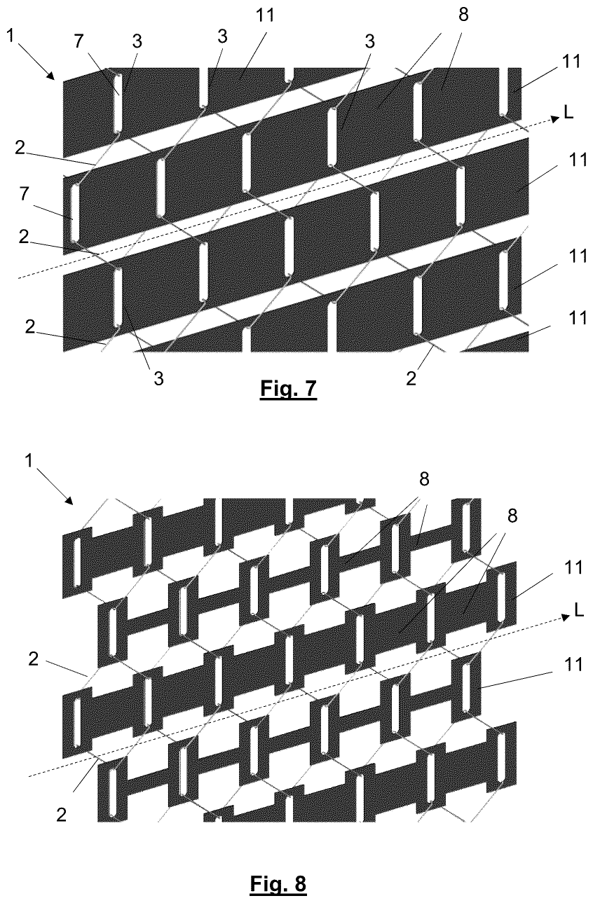

FIG. 7 shows a mesh 1 according to the invention in which all the links 3 attaching two consecutive wefts 2 are attached to one another by attachment portions 8, such that the links 3 between two wefts 2 form a single body 11.

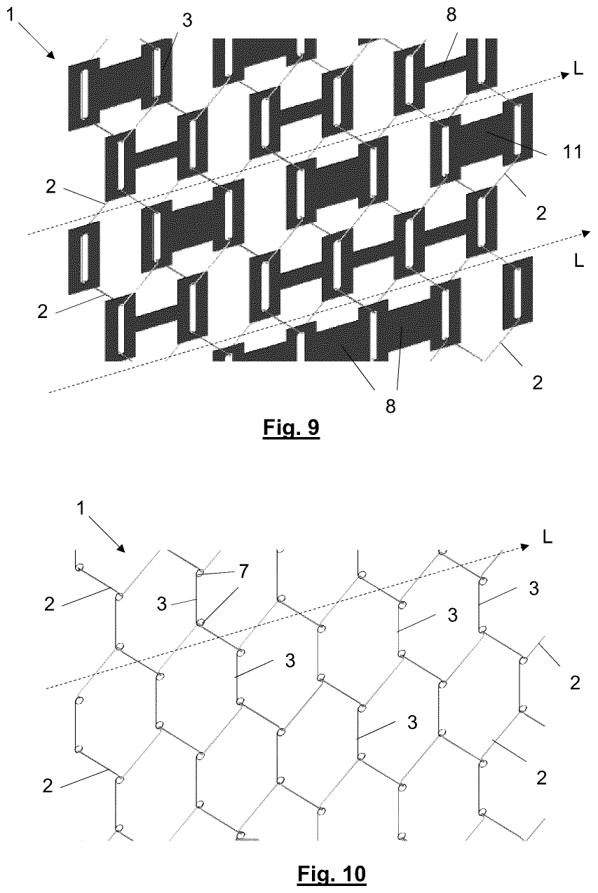

FIG. 8 shows a mesh 1 according to the present invention in which all the links 3 attaching consecutive two wefts 2 are also attached to one another by attachment portions 8, however, the attachment portions 8 are different in an alternating manner.

FIG. 9 shows another mesh 1 according to the present invention in which different types of links 3 are combined, attaching the same two consecutive wefts 2 and between different wefts 2. Thus it can be seen that the mesh 1 of the present invention is highly versatile and allows considerable combination of different links 3 attaching successive wefts 2. Depending on the desired constructive purpose of the mesh 1 and the shading effect to be obtained, one or another type of links 3 will be combined.

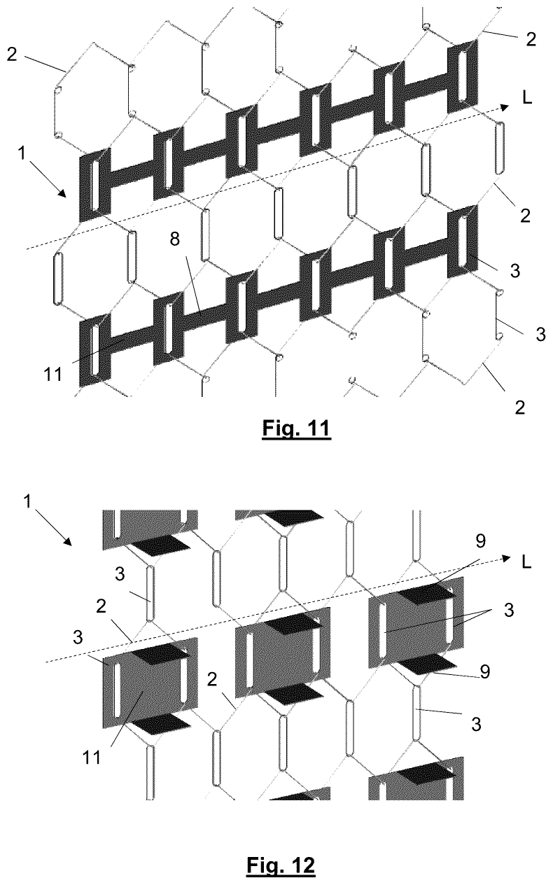

FIG. 10 shows another version of the mesh 1 according to the present invention in which in this case the links 3 have two through holes 7 through which each of the two successive wefts 2 passes. In this case, the two through holes 7 are attached by a filament, which prevents shades from being cast on the wall or surface on which the mesh 1 is arranged.

FIG. 11 shows another mesh 1 formed by the combinations of links 3 having attachment portions 8 therebetween, forming a single body 11 with individual links 3 that are not attached to one another. Therefore, a pendulum effect is achieved only between the wefts 2 attached to one another by means of individual links 3.

FIG. 12 shows another mesh 1 formed by the combinations of links 3 having attachment portions 8 therebetween, forming a single body 11 with links 3 attached in twos, provided with flanges 9, with individual links 3 that are not attached to one another. Not only a pendulum effect but also a particular shading effect is achieved.

FIG. 13 shows another mesh 1 the links 3 of which support accessory elements 14, in this case decorative sheets that can be fitted in the links 3.

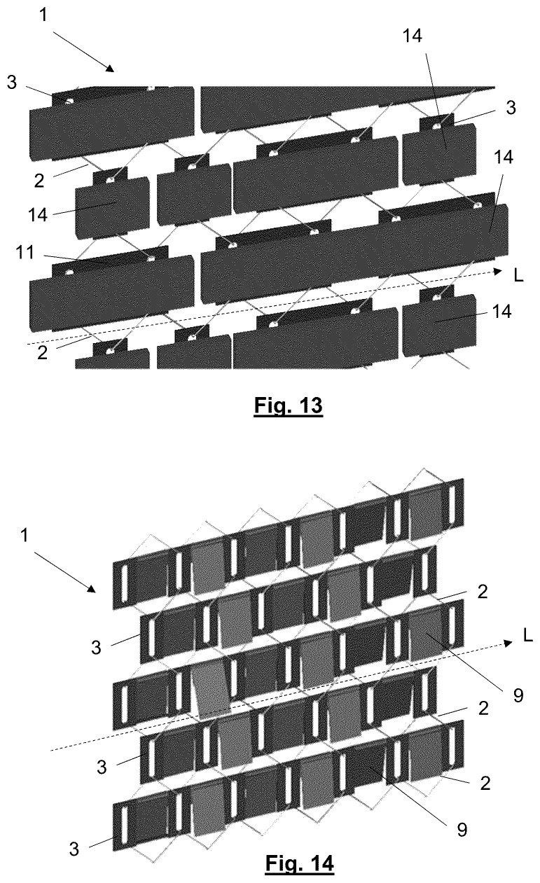

FIG. 14 shows another mesh 1 in which the attachment portions 8 have articulated flanges 9 that allow the movement of the flanges 9 due to the effect of wind.

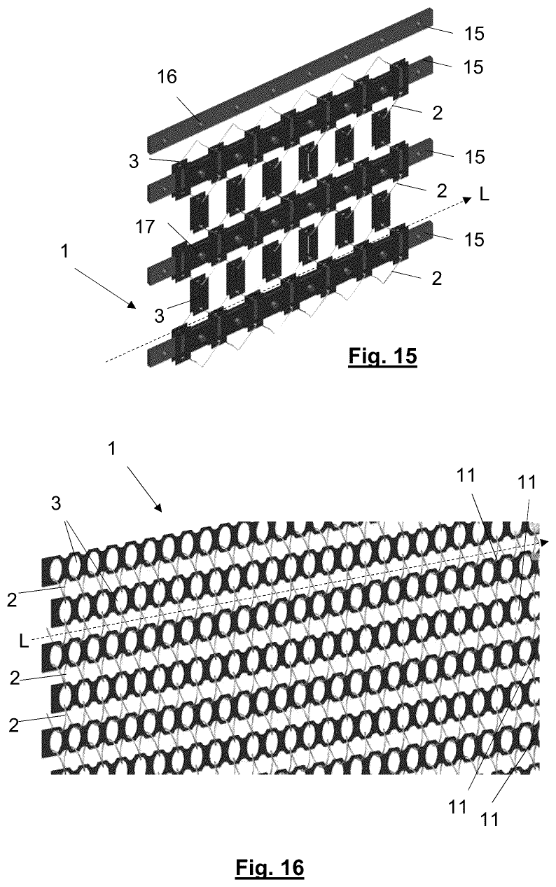

FIG. 15 shows a mesh 1 in which the links 3 surrounding a peak 4 and a valley 5 of successive wefts 2 are double links, thereby allowing strips 15 of material to be retained between the links 3, in this case it is envisaged that the strips 15 are strips with LEDs 16. In this case, it can furthermore be seen that the attachment portion 8 between the links 3 is provided with windows 17 to allow exposing the LEDs 16 of the strips 15.

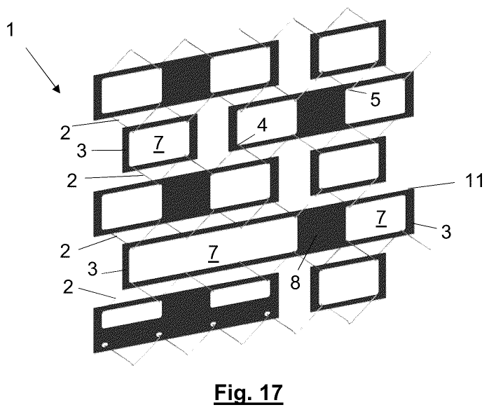

FIG. 16 shows another mesh 1 according to the invention in which the links 3 between two wefts 2 having a helicoidal, non-flattened spiral shape and furthermore forming a single body 11.

FIG. 17 shows another mesh 1 in which some of the through holes 7 of the links 3 allow surrounding more than one valley 5 or more than one peak 4 of one and the same weft 2. It is furthermore contemplated to combine different types of links 3, for example, of the types described above.

1. A wall lining mesh comprising a plurality of parallel wefts intended to be oriented preferably stacked at different levels and each extending over a length dimension; and a plurality of links connecting said wefts to one another, characterised in that the wefts have a spiral shape wound around a notional core of revolution or a notional core having a polygonal cross-section, each weft comprising an alternating sequence of peaks and valleys with segments which extend in a direction having a component normal to the length dimension and which can pass through links, with each link surrounding a peak and a valley of different wefts.

2. The mesh according to claim 1, characterised in that the wefts are helicoids.

3. The mesh according to claim 1, characterised in that the wefts are flattened helicoids.

4. The mesh according to claim 1, characterised in that it comprises links which are closed along the perimeter and have at least one through hole through which at least one of two successive wefts passes.

5. The mesh according to claim 1, characterised in that it comprises links having two through holes through which each of two successive wefts passes.

6. The mesh according to claim 4, characterised in that it comprises links having a single through hole through which two successive wefts pass.

7. The mesh according to claim 1, characterised in that it comprises links inscribed in planes parallel to one another.

8. The mesh according to claim 1, characterised in that at least two successive links connected to the same wefts are furthermore attached to one another by means of an attachment portion.

9. The mesh according to claim 1, characterised in that it comprises links provided with flanges.

10. The mesh according to claim 1, characterised in that the flanges are attached in an articulated manner to the links.

11. The mesh according to claim 1, characterised in that the wefts are filiform wefts.

12. The mesh according to claim 1, characterised in that the wefts are formed from a round or flat wire.

13. The mesh according to claim 1, characterised in that it comprises links formed from laser-cut or die-cut steel sheets.
